(19) United States
(12) Patent Application Publication
(10) Pub. No.: US 2023/0249357 A1
(43) Pub. Date: Aug. 10, 2023

(54) HANDICAP ACCESSIBILITY ASSISTANCE DEVICE

(71) Applicant: Continental Automotive Systems, Inc., Auburn Hills, MI (US)

(72) Inventors: Alexander Stege, Rochester, MI (US); Brian Saloka, Roseville, MI (US)

(73) Assignee: Continental Automotive Systems, Inc., Auburn Hills, MI (US)

(21) Appl. No.: 17/650,251

(22) Filed: Feb. 8, 2022

(51) Int. Cl. B25J 11/00

(52) U.S. Cl. CPC B25J 11/009; A61G 5/10

(57) ABSTRACT

A handicap accessibility assistance device includes a drone. The drone has a wedge mechanism at a first end. A controller is configured to cause the drone to approach a door, wedge the wedge mechanism under the door, shift the drone to an opening end of the door, and push the door open.

### TECHNICAL FIELD

The present disclosure relates generally to handicap accessibility, and more specifically to a drone for assisting handicapped individuals with entryway access.

### BACKGROUND

Individuals relying on mobility assistance devices such as manual wheelchairs, motorized wheelchairs, walkers, and the like can experience difficulty opening and closing entryway doors. In one instance, when the doors include handles or pulls positioned at a height designed for able bodied individuals, individuals using a wheelchair may have difficulty reaching and/or operating the handles or pulls. In another instance, when the doors have a particularly strong self-closing spring or are excessively heavy, a person using a mobility assistance device can have difficulty opening the door.

Some buildings include handicap accessible doors that either automatically open, or open in response to a button push. However, such doors may not be at every entrance or may be out of order and some buildings do not include this type of accessibility feature.

### SUMMARY OF THE INVENTION

In one exemplary embodiment a handicap accessibility assistance device includes a drone having a wedge mechanism at a first end and a controller configured to cause the drone to approach a door, wedge the wedge mechanism under the door, shift to an opening end of the door, and push the door open.

In another example of the above described handicap accessibility assistance device the wedge mechanism comprises an L-shaped bracket having a first portion extending vertically relative to a ground plane and a second portion extending horizontally from the first portion relative to the ground plane, and wherein the wedge mechanism is connected to a body of the drone via a slider.

In another example of any of the above described handicap accessibility assistance devices the wedge mechanism comprises a top surface of the drone, with the top surface being angled relative to a ground plane.

Another example of any of the above described handicap accessibility assistance devices further includes at least one stopper protruding outward from the top surface.

In another example of any of the above described handicap accessibility assistance devices the at least one stopper is configured to slide along the top surface.

In another example of any of the above described handicap accessibility assistance devices the at least one stopper comprises a pair of adjacent stoppers configured to slide along parallel tracks.

In another example of any of the above described handicap accessibility assistance devices the drone comprises a set of wheels connected to a body of the drone and configured to drive the drone.

In another example of any of the above described handicap accessibility assistance devices the set of wheels are directly connected to a drive train, and the drive train is connected to the drone body via a swiveling mount.

In another example of any of the above described handicap accessibility assistance devices the set of wheels comprises mecanum wheels.

In another example of any of the above described handicap accessibility assistance devices further includes at least one handle extending upward from the drone.

Another example of any of the above described handicap accessibility assistance devices further includes a mobility assistance device having a docking station for the drone, the mobility assistance device further including a controller for at least partially controlling the drone.

In another example of any of the above described handicap accessibility assistance devices the mobility assistance device is one of a manual wheelchair, a motorized wheelchair, a scooter, and a walker.

An exemplary method for operating a handicap accessibility assistance device includes deploying a drone from a mobility assistance device, driving the drone until the drone contacts a door using a controller and wedging at least a portion of a wedge mechanism under the door, pushing the door open using the drone, and retrieving the drone by automatically driving the drone back to the mobility assistance device in respond to an indication from a user that the mobility assistance device has passed through a doorway.

In another example of the above described method for operating a handicap accessibility assistance device wedging the at least a portion of the wedge mechanism under the door comprises increasing a downforce on a set wheels by driving an angled top surface of the drone under the door.

Another example of any of the above described methods for operating a handicap accessibility assistance device further includes preventing the drone from wedging too far under the door by positioning a stopper on the angled top surface.

In another example of any of the above described methods for operating a handicap accessibility assistance device wedging the at least a portion of the wedge mechanism under the door comprises sliding a horizontal portion of an L-shaped bracket under the door and lifting the L-shaped bracket.

Another example of any of the above described methods for operating a handicap accessibility assistance device further includes driving the drone along the door to an edge of the door in response to the drone contacting the door.

In another example of any of the above described methods for operating a handicap accessibility assistance device driving the drone along the door comprises driving the drone using a set of Mecanum wheels.

In another example of any of the above described methods for operating a handicap accessibility assistance device driving the drone along the door comprises rotating a drivetrain relative to a body of the drone such that the drivetrain is parallel to the door.

In another example of any of the above described methods for operating a handicap accessibility assistance device the mobility assistance device is one of a wheelchair and a walker.

These and other features of the present invention can be best understood from the following specification and drawings, the following of which is a brief description.

### BRIEF DESCRIPTION OF THE DRAWINGS

FIG. 1 schematically illustrates an exemplary building entrance.

FIG. 2 schematically illustrates an example accessibility assistance drone.

FIG. 3 schematically illustrates an alternate configuration of the accessibility assistance drone.

FIG. 4 schematically illustrates a first example drive system for the accessibility assistance drone.

FIG. 5 schematically illustrates a second example drive system for the accessibility assistance drone.

FIG. 6A illustrates an a sequence of a door opening process.

FIG. 6B illustrates a finishing step of the door opening process of FIG. 6A.

### DETAILED DESCRIPTION

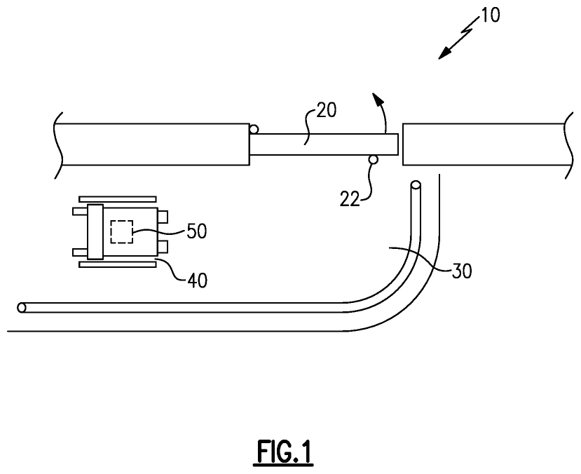

FIG. 1 schematically illustrates an exemplary building entryway 10 including a door 20 for a building. The door 20 swings into the building to allow people access to the building. A walkway 30 leads up to the door 20 and provides a handicap accessible ramp access. The door 20 opens via pushing on the door 20. Due to the narrow turn of the walkway 30, a person using a wheelchair, or similar mobility assistance device may have difficulty opening the door due to the weight of the door 20, the strength of self-closing springs, the push resistance of the door due to pressure differential, or any similar features.

In order to access the building 10 by opening the door 20, a wheelchair 40 includes a deployable door access assistance drone 50. The deployable door access assistance drone is a small portable drone vehicle that is carried on or in a mobility assistance device (the wheelchair 40) and can be deployed by the user of the mobility assistance device to open a door or similar entryway. The drone 50 is wirelessly connected to the mobility assistance device, or to a computing device such as a smart phone, on or in the mobility assistance device. The wireless connection allows the drone 50 to receive commands from the user of the mobility assistance device and allows the drone to return to a docking position on the mobility assistance device or to the user. In some examples, the drone 50 can return to the operator by following a light signal. In alternative examples, a GPS or other location sensor can provide the directional information required for the drone 50 to return. As used herein “wedge mechanism” refers to a structural feature that extends from the body of the drone 50 and under the door 20.

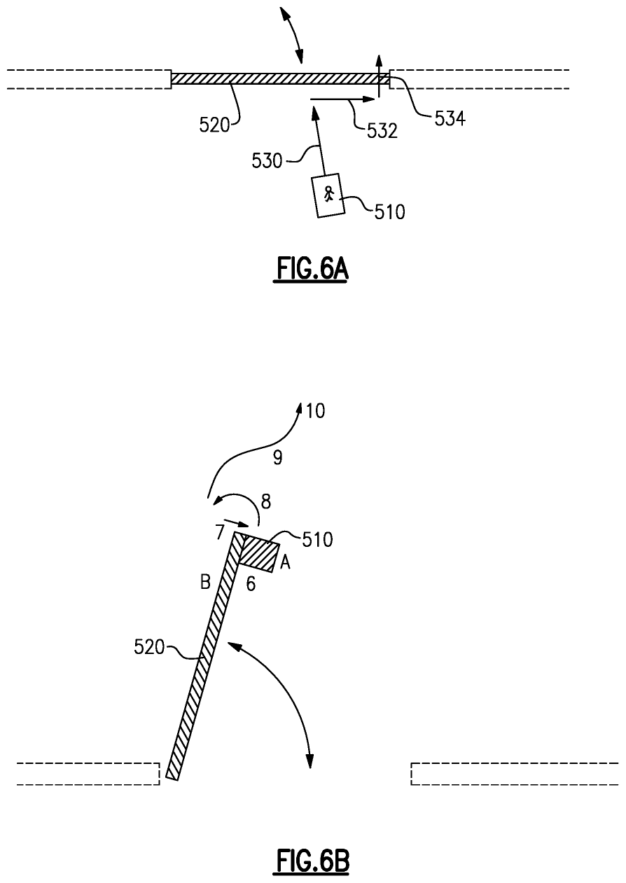

In a typical example the drone 50 is deployed manually by the user as the user approaches the door 20, and commanded to return to the user once the user has passed through the door 20. In order to provide sufficient traction that the drone 50 can force the door 20 open (e.g. for heavy or spring-loaded doors), the drone 50 includes a wedge mechanism that goes under the door 20 and leverages the door 20 to push traction wheels on the drone 50 against the floor. While illustrated with a manually operated wheelchair for explanatory purposes, it is understood that the drone 50 can be used with any mobility assistance device and is not limited to the illustrated wheelchair 40. In order to further optimize the leverage, and have the ability to clear the door 20 after the mobility assistance device has passed through the door 20, the drone 50 includes a mechanism for driving sideways along the door 20. In some examples this can be achieved by either a rotatable drivetrain (e.g., FIG. 4) or a set of mecanum wheels (e.g., FIG. 5).

With continued reference to FIG. 1, FIG. 2 illustrates a side view 100 of a first drone 110 positioned at a door 120. The drone 110 includes a wedge shaped chassis with a narrow end having a low enough clearance to slide under the door 120, and provide leverage forcing the chassis 112 toward the floor, thereby providing sufficient traction at the wheels 114. The drone 110 includes a drivetrain 116 configured to drive the wheels 114. The drivetrain 116 includes a force gauge 132 that determines the force of the wheels 114 against the floor 140 and provides the force measurement to a controller at the mobility assistance device. The force measurement can be used by the controller to adjust the drone 100 to an optimal position for pushing the door open and/or to detect that the wedge portion of the drone 100 has sufficiently slid under the door 120. In some examples, the drivetrain 116 can include a lifter 160 to push the wedge up against the door 120, thereby allowing the wedge to be shorter with a steeper angle and preventing the wedge from getting stuck on thresholds, bumps, or similar features protruding from the floor 140.

In order to prevent the drone 110 from sliding too far under the door 120, an actuated stopper 150 is positioned on the angled surface of the wedge, and is configured to be actuated along a line 152 parallel to the angled surface 113. When the drivetrain 116 of the drone 120 detects that a predetermined amount of downward force has been reached, the drone 110 slides the stopper 150 toward the door 120 until the stopper 160 is in contact with the door 120. This action prevents the drone 110 from sliding too far under the door 120. Further, when the drone 110 is adjusting a position along the door 120, the stopper 160 can be shifted further forward, allowing the drone 110 to have a smaller amount of downward force and easing the ability for the drone 120 to shift sideways along the door 120. Once in position, the stopper 150 can be slid backwards allowing for the drone 110 to be wedged further under the door 120, increasing the downforce and allowing for punishing to occur.

At a rear end of the drone, behind the stopper 150, is an optional handle 170. The optional handle 170 facilitates retrieval by the operator, and can be configured in any easy to grab configuration.

While the example drone 110 is illustrated with the entire body being wedge shaped, it is anticipated that at least a portion of the body extending behind the wedge can be a different shape, provided the wedge surface 113 is sufficiently long.

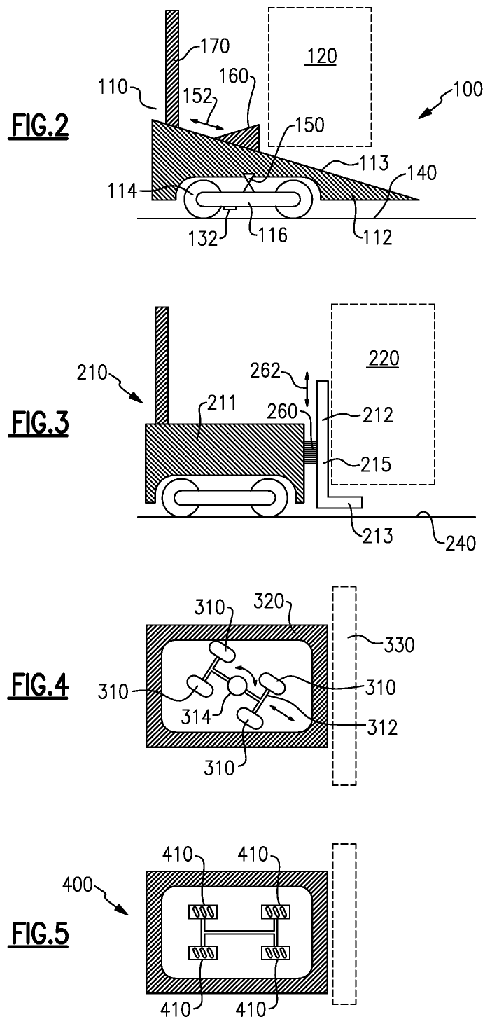

In some alternate configurations, such as the drone 210 illustrated in FIG. 4, the wedge surface can be replaced with an L-shaped arm 212 extending from the front of the body 211 of the drone 210. The arm 212 is connected to the body 211 at a generally vertical portion 215 via a slider 260. A lower portion 213 extends from the base of the arm 212, and is low enough to the ground 240 to fit in a gap under the door 220. The slider 260 raises and lowers the L-shaped arm 212 similar to forklift operations, and provides similar downforce generation as that provided by the wedge shaped body of FIG. 3.

In yet another example alternative, the drone can include a wedge shaped body on one end, and an L-shaped arm on the opposite end, and the operator can select the most appropriate tool for a given access point.

With continued reference to all of the above described drones, FIG. 4 schematically illustrates an exemplary bottom view of either drone 110, 210 using a drivetrain 312 and includes a set of wheels 310 mounted to the drive train 312. The chassis body 320 is connected to the drive train 312 via a swiveling mount 314. The chassis body 320 can be rotated around the vertical axis of the drone using the swivel mount 314. The wheels 310 slide perpendicular to their driving direction as the drivetrain 312 is rotated as long as the drone is not in a wedged position, or other position where the downforce on the drone exceeds a preset force. In operation, the drivetrain rotates while the chassis body 320 is in contact with the door 330 and the contact with the door 330 keeps the chassis body 320 straight causing the drive train 312 to rotate (as the wheels slide) rather than the chassis body 320. This configuration allows the drone to slide sideways along the floor to reach a position in the door 330 with the best leverage before opening the door 330.

With continued reference to FIG. 4, FIG. 5 illustrates an alternate exemplary drive system 400 for a drone using a set of mecanum drive wheels 410 instead of the swivel mounted drive train 312 of FIG. 4. A mecanum drive is a method of driving a drone or other robotic vehicle using specially designed wheels that allow the drone to drive in any direction without changing the orientation of the robot. Aside from the use of Mecanum wheels, the drone of FIG. 5 is configured and operates similar to that of FIG. 4.

With continued reference to FIGS. 1-5, FIGS. 6A and 6B illustrate operation of a drone 510 to open a door 520 with the initial deployment of the drone 510 being illustrated in FIG. 6A and the door 520 being completely opened in FIG. 6B. Initially as the operator approaches the door 520, the drone 510 is activated and deployed from the mobility assistance device. The drone approaches the door in a straight line 530 from the location of deployment. At the same time as the activation, the user selects whether the door opens from the left or right side and manually orients the drone 510 toward the door 520.

Once the drone 510 detects that it has reached the door 520, and the wedge portion has passed under the door 520 sufficiently, the drone 510 begins moving sideways along the door 520 to the right or left end as indicated by the user when the drone 510 was deployed. In the example, the drone moves right to the right end along a line 532.

When the drone hits the end of the door 520, the drone begins wedging itself under the door to increase the downforce until the desired level of downforce is reached. After reaching the desired level of downforce, the stopper (if present) is shifted to the correct location, and the drone begins pushing into the door along line 534 in order to open the door. Once the door has been opened (FIG. 6B), the drone receives a “door open” wireless signal indication from the user and stops pushing the door 520.

After the user has passed through the entryway, the drone 510 receives a second wireless signal from the user indicating that the user and the mobility assistance device have cleared the doorway, and the drone 510 allows the door to close. During the door closing the drone 510 is pushed clear of the door due to a combination of sideways motion and centrifugal force due to the door swinging shut. In examples including the stopper, the drone uses the actuated stopper to push the drone out from underneath the door. When the drone utilizes a pair of side-by-side actuated stoppers, the stoppers can be actuated asymmetrically. The asymmetric actuation provides a spin on the drones movement and further assists in clearing the door. Once clear of the door 520, the drone 510 returns to a base station at the mobility assistance device and can be recharged or stowed for future uses.

With continued reference to each of the drones disclosed above, it is further anticipated that the drone can include one or more handholds to facilitate easy lifting/setting down of the drone. The handholds can be either permanent handles extending outward from the drone, attachable or foldable handles extending outward from the drone, or hand sized indentions into a body of the drone.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A handicap accessibility assistance device comprising:
a drone having a wedge mechanism at a first end and a controller configured to cause the drone to approach a door, wedge the wedge mechanism under the door, shift to an opening end of the door, and push the door open.

2. The handicap accessibility assistance device of claim 1, wherein the wedge mechanism comprises an L-shaped bracket having a first portion extending vertically relative to a ground plane and a second portion extending horizontally from the first portion relative to the ground plane, and wherein the wedge mechanism is connected to a body of the drone via a slider.

3. The handicap assistance device of claim 1, wherein the wedge mechanism comprises a top surface of the drone, with the top surface being angled relative to a ground plane.

4. The handicap assistance device of claim 3, further comprising at least one stopper protruding outward from the top surface.

5. The handicap assistance device of claim 4, wherein the at least one stopper is configured to slide along the top surface.

6. The handicap assistance device of claim 4, wherein the at least one stopper comprises a pair of adjacent stoppers configured to slide along parallel tracks.

7. The handicap assistance device of claim 1, wherein the drone comprises a set of wheels connected to a body of the drone and configured to drive the drone.

8. The handicap assistance device of claim 7, wherein the set of wheels are directly connected to a drive train, and the drive train is connected to the drone body via a swiveling mount.

9. The handicap assistance device of claim 7, wherein the set of wheels comprises mecanum wheels.

10. The handicap assistance device of claim 1, further comprising at least one handle extending upward from the drone.

11. The handicap assistance device of claim 1, further comprising a mobility assistance device having a docking station for the drone, the mobility assistance device further including a controller for at least partially controlling the drone.

12. The handicap assistance device of claim 10, wherein the mobility assistance device is one of a manual wheelchair, a motorized wheelchair, a scooter, and a walker.

13. A method for operating a handicap accessibility assistance device comprising:
deploying a drone from a mobility assistance device;
driving the drone until the drone contacts a door using a controller and wedging at least a portion of a wedge mechanism under the door;
pushing the door open using the drone; and
retrieving the drone by automatically driving the drone back to the mobility assistance device in respond to an indication from a user that the mobility assistance device has passed through a doorway.

14. The method of claim 13, wherein wedging the at least a portion of the wedge mechanism under the door comprises increasing a downforce on a set wheels by driving an angled top surface of the drone under the door.

15. The method of claim 14, further comprising preventing the drone from wedging too far under the door by positioning a stopper on the angled top surface.

16. The method of claim 13, wherein wedging the at least a portion of the wedge mechanism under the door comprises sliding a horizontal portion of an L-shaped bracket under the door and lifting the L-shaped bracket.

17. The method of claim 13, further comprising driving the drone along the door to an edge of the door in response to the drone contacting the door.

18. The method of claim 17, wherein driving the drone along the door comprises driving the drone using a set of Mecanum wheels.

19. The method of claim 17, wherein driving the drone along the door comprises rotating a drivetrain relative to a body of the drone such that the drivetrain is parallel to the door.

20. The method of claim 13, wherein the mobility assistance device is one of a wheelchair and a walker.
